(19) United States
(12) Patent Application Publication
(10) Pub. No.: US 2025/0045576 A1
(43) Pub. Date: Feb. 6, 2025

(54) CONTINUOUS-VALUED MATRIX PRODUCT STATES

(71) Applicant: Zapata Computing, Inc., Boston, MA (US)

(72) Inventors: Alexander Meiburg, Santa Barbara, CA (US); Jing Chen, Bayonne City, NJ (US); Jacob Miller, Montreal (CA); Alejandro Perdomo Ortiz, Toronto (CA)

(21) Appl. No.: 18/595,480

(22) Filed: Mar. 5, 2024

Related U.S. Application Data
(60) Provisional application No. 63/450,163, filed on Mar. 6, 2023.

(51) Int. Cl. G06N 3/08; G06N 3/0495

(52) U.S. Cl. CPC G06N 3/08; G06N 3/0495

(57) ABSTRACT

A computer system may train a continuous variable tensor network on a dataset, to reproduce a model, the trained continuous variable tensor network having a first set of parameters, the model having a second set of parameters, wherein a first cardinality of the first set of parameters is less than a second cardinality of the second set of parameters. The computer system may sample the trained continuous variable tensor network to produce synthetic data samples.

### BACKGROUND

Quantum computers promise to solve industry-critical problems which are otherwise unsolvable or only very inefficiently addressable using classical computers. Key application areas include chemistry and materials, bioscience and bioinformatics, logistics, and finance. Interest in quantum computing has recently surged, in part due to a wave of advances in the performance of ready-to-use quantum computers.

Generative modeling is a cornerstone of modern machine learning, providing the ability to create new data samples that are representative of a given distribution. This capability is crucial across a wide array of applications, from image and speech synthesis to drug discovery and financial modeling. In particular, the ability to model and generate continuous data is of paramount importance in capturing the complexities of real-world phenomena.

One of the significant challenges in generative modeling is the efficient representation and processing of high-dimensional data. Traditional methods often require a substantial amount of computational power and memory, which can be prohibitive, especially when dealing with large datasets common in fields such as quantum physics and big data analytics.

Furthermore, as models grow in complexity to capture intricate data patterns, they become increasingly difficult to store, process, and deploy. The number of parameters in such models can be vast, leading to challenges not only in computational and storage requirements but also in the risk of overfitting and the difficulty of model interpretation.

Another problem area is the limitation of many existing generative models to handle only binary or categorical data. Continuous data, which is prevalent in numerous real-world applications, poses unique challenges that are not adequately addressed by these models. The ability to process and generate continuous data with high fidelity is essential for the advancement of generative modeling techniques.

Additionally, the optimization of generative models for performance and resource utilization is a non-trivial task. Techniques that can dynamically adjust model complexity and computational cost without sacrificing accuracy are needed to make generative modeling more practical and accessible.

Data preprocessing is also a critical step in the modeling process. Properly preparing continuous data for training, such as through normalization and scaling, can significantly impact the performance of generative models. However, existing methods may not offer the flexibility or efficiency required for optimal preprocessing, particularly when dealing with diverse datasets.

Lastly, the scalability and accessibility of advanced generative models are limited by the need for substantial computational infrastructure. Smaller organizations or those without specialized hardware may find it challenging to deploy state-of-the-art models, thus hindering the broader adoption of these technologies.

In light of these challenges, there is a clear need for improved methods and systems for generative modeling of continuous data that address the issues of high-dimensional data representation, model compression, efficient handling of continuous data, optimization of resource usage, effective data preprocessing, and enhanced scalability and accessibility for commercial applications.

### SUMMARY

Computer-implemented systems and methods generate a tensor network-based generative model, specifically utilizing matrix product states (MPS), which is capable of efficiently representing and processing high-dimensional continuous data. The systems and methods incorporate a novel trainable compression layer within the MPS framework, which significantly reduces the model's complexity and resource requirements, while maintaining its ability to approximate complex probability density functions with high fidelity. This approach addresses the challenges of model scalability and computational efficiency, making advanced generative modeling more accessible and practical for real-world applications.

### BRIEF DESCRIPTION OF THE FIGURES

FIG. 1 is a diagram of a quantum computer according to one embodiment of the present invention;

FIG. 2A is a flowchart of a method performed by the quantum computer of FIG. 1 according to one embodiment of the present invention;

FIG. 2B is a diagram of a hybrid quantum-classical computer which performs quantum annealing according to one embodiment of the present invention; and

FIG. 3 is a diagram of a hybrid quantum-classical computer according to one embodiment of the present invention.

### DETAILED DESCRIPTION

The present invention relates to a computer-implemented method for compressing generative models for continuous data using tensor networks. Throughout this specification, numerous instances reference the use of Matrix Product States (MPS) in the context of the Continuous Variable Tensor Network (CVTN). It is important to clarify that while MPS are prominently featured as a specific embodiment of tensor networks (TNs), the principles and functionalities described herein are not confined solely to MPS. Rather, MPS serve as illustrative examples of the broader class of TNs, and the references to MPS should be understood as being equally applicable to TNs in general.

Tensor networks represent a versatile framework for organizing and manipulating high-dimensional tensors in a structured manner. MPS, being a particular type of TN, exemplify the capabilities and advantages of TNs in efficiently representing quantum states and facilitating complex computations. However, the inventive concepts, methodologies, and applications detailed within this specification are not restricted to MPS alone but extend to encompass various other forms of TNs.

The broader category of TNs includes, but is not limited to, Tree Tensor Networks (TTN), Projected Entangled Pair States (PEPS), Multi-scale Entanglement Renormalization Ansatz (MERA), Tensor Trains (TT), and Tensor Rings (TR), among others. Each of these TN architectures offers unique features and may be more suitable for specific data structures, dimensions, or computational tasks. The choice of a particular TN architecture within the scope of this invention would depend on the specific requirements of the application, the nature of the data, and the desired properties of the model.

Therefore, any reference to MPS within this specification should be interpreted as an example of the broader concept of TNs. The invention is intended to cover all such TN architectures and their respective implementations. The use of MPS as a representative example is for illustrative purposes only and should not be construed as limiting the invention to MPS. The disclosed invention is fully intended to be implemented using any suitable TN architecture, thereby ensuring that the scope of the invention encompasses the full breadth of TN applications and benefits.

The method involves training a tensor network on a dataset to approximate a target probability density function represented by the generative model. A trainable compression layer is applied to the tensor network to reduce the cardinality of the tunable tensors, achieving a compressed network that maintains the ability to approximate the target function with high precision. The compression layer includes a plurality of isometry matrices that rotate and truncate the feature space, optimizing the network's memory and computational resource usage. The tensor network is further optimized using gradient descent and Density Matrix Renormalization Group (DMRG) techniques. Additionally, the method includes preprocessing steps for the dataset, such as normalization, scaling, and dynamic basis adjustment, to enhance the network's performance. The trained and compressed tensor network can be sampled to produce synthetic data samples for various applications, including but not limited to finance, healthcare, and logistics. The invention also contemplates packaging the technology into software modules for integration into data analytics platforms, licensing to third parties, and deployment as a cloud-based service, offering scalable and efficient generative modeling capabilities.

Embodiments of the Present Invention compress generative models for continuous data using tensor networks, including matrix product states (MPS), for several compelling reasons, and to obtain several significant benefits, such as:

Efficient Representation of High-Dimensional Data: Tensor networks, and MPS in particular, provide a structured way to factorize high-dimensional tensors into chains of lower-dimensional tensors. This structure is inherently more memory-efficient and computationally tractable than dealing with the full high-dimensional space directly, making it well-suited for representing complex data distributions.

Scalability and Computational Resource Management: By introducing a compression layer within the MPS, the invention further reduces the number of parameters required to capture the essential features of the data distribution. This compression not only decreases the storage and computational load but also allows the model to scale more effectively to larger datasets and higher-dimensional problems without a proportional increase in resource demand.

Preservation of Model Performance: Despite the reduction in complexity, the MPS-based approach is designed to retain a high level of expressiveness. The tensor network can approximate any reasonably smooth probability density function with arbitrary precision, ensuring that the model's performance in generative tasks remains robust even after compression.

Adaptability to Continuous Data: Traditional tensor networks are often limited to discrete data. The inventive MPS model overcomes this limitation by incorporating continuous variables into the network, thus expanding the applicability of tensor networks to a broader range of datasets that include continuous data, which is common in many real-world scenarios.

In summary, embodiments of the present invention leverage the strengths of MPS tensor networks to create a compressed yet powerful generative model that is capable of handling the complexities of continuous data with improved efficiency and scalability.

Embodiments of the present invention perform the compression of generative models through the following steps:

Feature Mapping and Dimensionality Reduction: The continuous input data is first mapped onto a higher-dimensional feature space using a set of basis functions, such as polynomials or Fourier series. This mapping transforms continuous variables into a format suitable for tensor network processing. The invention then employs a trainable compression layer that reduces the dimensionality of this feature space, selecting the most relevant features for the generative model.

Isometry Matrices: The compression layer consists of isometry matrices, which are essentially partial unitary matrices that perform a rotation and truncation of the feature space. These matrices are optimized during training to best represent the data while minimizing the number of features, effectively compressing the model.

The continuous MPS applies an isometry to map [symbol] into a space of functions, for instance, the polynomials of degree at most d−1. We can view this as an additional isometry belonging to the tensor network, that produces an tensor network state (TNS) with continuous-valued real states. Another view is that the [symbol] state is measured with a non-orthogonal POVM. The equivalence is a consequence of Naimark's dilation theorem.

For numerical applications, one may represent the mapping unitary U as a vector of d functions fᵢ: [symbol] → [symbol] . It does not have to be orthnormal, since non-orthnormal may be transformed into orthnormal ones.

The continuous-valued MPS is given by:

$$Φ ( x ) = {\sum }_{{i}_{1} , {i}_{2} , … , {i}_{n}} ( {\prod }_{j = 1}^{N} ⊗ {f}_{{i}_{k}} ( {x}_{k} ) ) ψ ( s )$$

Where ψ(s) is the discrete valued MPS with s=(i₁, . . . , iₙ).

When an MPS is sampled, we proceed site by site, conditioning the sample at site i on the previous sites {1, 2, . . . , i−1} by contracting the MPS at each site.

The MPS is trained in the following way. In the continuous variable MPS, the feature functions {fᵢ(x)} are primarily chosen. Only the tensors of ψ(s) are tunable parameters. Given a dataset with continuous data, each datum can be mapped in a direct product of vectors defined in each site. At each particular site it is mapped from a continuous value into a vector. For a dataset with N sites, the ith sample {x₁⁽ⁱ⁾, x₂⁽ⁱ⁾, . . . , xₙ⁽ⁱ⁾} is mapped into

$${v}_{1}^{( i )} ⊗ {v}_{2}^{( i )} ⊗ … ⊗ {v}_{N}^{( i )} = {\prod }_{k = 1}^{N} ⊗ ( \begin{matrix}{f}_{1} ( {x}_{k}^{( i )} ) \\ ⋮ \\ {f}_{N} ( {x}_{k}^{( i )} )\end{matrix} )$$

where vₖ⁽ⁱ⁾ is the discrete vector representation of ith sample at site k.

The NLL requires summation over all data samples, the site index of ψ(s) are contracted with the feature vectors.

The MPS can then be trained to learn this dataset by any conventional means, such as gradient descent on the NLL of the distribution, or an adapted version of DMRG.

To train at a pair of sites (i, i+1), the state |ψ(x) [symbol] is contracted into the MPS at all sites from 1 to i−1 and from n to i+2. The remaining bond tensor is optimized according to the procedure described in Zhao-Yu Han, Jun Wang, Heng Fan, Lei Wang, and Pan Zhang, “Unsupervised generative modeling using matrix product states,” PRX 8, 031012 (2018).

Matrix Product State (MPS) Optimization: The compressed feature vectors are then connected to an MPS tensor network. The MPS is optimized using techniques such as gradient descent and Density Matrix Renormalization Group (DMRG) methods to ensure that the compressed model accurately approximates the target probability density function.

Dynamic Adjustment of Bond Dimensions: During training, the bond dimensions of the MPS-hyperparameters that control the model's expressiveness and computational cost—can be dynamically adjusted. This allows for an acceptable trade-off between the model's accuracy and the resources required for computation and storage.

Hybridization of Basis Functions: The invention may also include methods for dynamically adjusting the basis functions used in the feature mapping process. By hybridizing and reweighting these functions, the model can adapt to the specific characteristics of the data, further enhancing compression without loss of generative performance.

Through these mechanisms, embodiments of the present invention compress generative models by reducing the number of parameters and computational complexity, while maintaining or even enhancing the model's ability to generate high-quality synthetic data that mirrors the distribution of the continuous input data.

Although reference is made herein to using matrix product states to perform a variety of functions, this is merely an example and does not constitute a limitation of the present invention. Tensor networks other than matrix product states (MPS) may be used within embodiments of the invention. While MPS are a popular choice due to their simplicity and efficiency in one-dimensional systems, other types of tensor networks may be employed to address specific needs or to better handle data with different structures and dimensionalities. Some alternative tensor network architectures that could be considered include:

Tree Tensor Networks (TTN): These networks organize tensors in a hierarchical, tree-like structure, which can be advantageous for capturing hierarchical relationships within data and may be more suitable for certain types of datasets.

Projected Entangled Pair States (PEPS): Also known as tensor product states, PEPS are a generalization of MPS to higher dimensions and can be particularly useful for modeling two-dimensional data or data with grid-like topologies.

Multi-scale Entanglement Renormalization Ansatz (MERA): This network is designed to capture scale-invariance and criticality and is often used in quantum many-body systems. It could be adapted for data that exhibit self-similarity or fractal-like properties.

Tensor Trains (TT): Similar to MPS, tensor trains decompose high-dimensional tensors into a sequence of three-dimensional tensors. They are particularly effective for problems where the data can be naturally arranged in a sequential or chain-like manner.

Tensor Ring (TR): Tensor rings generalize the concept of tensor trains by connecting the ends of the tensor chain, forming a ring-like structure. This can be beneficial for modeling periodicity and circular relationships in data.

The choice of tensor network architecture within embodiments of the invention would depend on the specific characteristics of the data, the desired properties of the generative model, and the computational resources available. Each tensor network type offers unique advantages and may be more suitable for certain applications, allowing the invention to be tailored to a wide range of generative modeling tasks.

As previously mentioned, embodiments of the present invention may include a method which trains an MPS tensor network on a dataset to approximate a target probability density function represented by the generative model. The training process begins with the preparation of the dataset, where each data sample is represented by a vector of continuous variables. These vectors are then mapped onto a higher-dimensional feature space using a predefined set of basis functions, effectively transforming the continuous variables into a form amenable to tensor network processing.

Once the data is prepared, the MPS tensor network is constructed. An MPS is a sequence of tensors arranged in a one-dimensional chain, where each tensor is connected to its neighbors by shared indices known as “bonds.” The dimensionality of these bonds, referred to as the bond dimension, is a hyperparameter that controls the capacity of the MPS to model correlations within the data.

The objective of training is to adjust the parameters of the MPS-namely, the tensor elements-such that the resulting MPS represents a PDF that closely approximates the target PDF of the dataset. To achieve this, the method employs optimization techniques such as gradient descent or the Density Matrix Renormalization Group (DMRG) algorithm. These techniques iteratively update the tensor elements to minimize a loss function that quantifies the difference between the MPS-generated PDF and the target PDF.

During training, the MPS may undergo a process of bond dimension adjustment, where the bond dimensions are dynamically increased or decreased. This allows the MPS to adapt its complexity to the structure of the data, ensuring an efficient representation that balances model expressiveness with computational efficiency.

The training process continues until the MPS-generated PDF converges to the target PDF within a desired level of accuracy, as determined by the loss function. Upon convergence, the trained MPS tensor network serves as the generative model, capable of sampling new data points that follow the learned distribution.

The trained MPS generative model thus encapsulates the statistical properties of the original dataset and can be used to generate new, synthetic data samples for various applications, such as data augmentation, anomaly detection, and simulation of complex systems. The method's ability to accurately model continuous data distributions with an MPS tensor network represents a significant advancement in the field of generative modeling.

Several types of basis functions may be used for feature mapping of continuous data to transform it into a suitable form for processing by the tensor network. The choice of basis functions can significantly influence the model's ability to capture the underlying structure of the data. Here are some examples of basis functions that could be employed:

Polynomials: These include monomials (x∧n) or orthogonal polynomials like Legendre polynomials, which are defined on a closed interval (typically [−1, 1]) and are particularly useful for data that is non-periodic and bounded.

Fourier Series: Comprising sine and cosine functions, the Fourier basis is ideal for periodic data or data defined on a circular domain. It can capture frequency-based patterns within the data.

Hermite Polynomials: Accompanied by a Gaussian weight, these polynomials are defined on the entire real line and are suitable for data that can take any real value, effectively capturing the behavior of data with a Gaussian-like distribution.

Laguerre Polynomials: These are polynomials multiplied by an exponential decay, defined for non-negative values, making them appropriate for datasets where the variables are strictly positive.

Wavelets: Wavelet functions can localize data in both time and frequency space, making them useful for data with localized features or abrupt changes.

Radial Basis Function (RBF): Including Gaussian, multiquadric, and inverse quadratic functions, RBFs are useful for multidimensional interpolation and can handle data distributed over irregular domains.

Bessel Functions: These functions are suitable for data defined over a circular or spherical domain and can be used for problems with radial symmetry.

Chebyshev Polynomials: Defined on a closed interval, these polynomials are useful for approximating functions with a minimax property, which minimizes the maximum error between the function and its polynomial approximation.

Spline Functions: Splines, including B-splines and cubic splines, offer piecewise polynomial representations that are smooth and flexible for modeling data with varying smoothness.

The selection of basis functions is typically guided by the nature of the data, the domain of definition, and the desired properties of the feature space. The basis functions should be chosen to facilitate efficient learning and accurate representation of the continuous variables by the tensor network.

Training the MPS to match the target probability distribution involves optimizing the parameters of the MPS so that the probability distribution it represents closely approximates the target distribution. The optimization process requires both appropriate optimization techniques and loss functions to guide the training. Here are some commonly used optimization techniques and loss functions for this purpose:

### Optimization Techniques:

Gradient Descent (GD): This is a fundamental optimization algorithm that updates the parameters in the direction of the negative gradient of the loss function with respect to the parameters. Variants such as stochastic gradient descent (SGD) and mini-batch gradient descent can be used to handle large datasets.

Density Matrix Renormalization Group (DMRG): Originally developed for quantum physics, DMRG is an iterative algorithm for finding the ground state of quantum systems. In the context of MPS, it is adapted to iteratively optimize the tensors while keeping the bond dimensions under control.

Variational Methods: These methods frame the optimization as a variational problem, where the goal is to find the MPS that minimizes the energy (or cost) associated with the target distribution.

Automatic Differentiation: Leveraged by modern machine learning frameworks, automatic differentiation enables the computation of gradients for complex functions, facilitating the implementation of gradient-based optimization methods.

Adam Optimizer: An extension of gradient descent, Adam is an algorithm for first-order gradient-based optimization of stochastic objective functions, based on adaptive estimates of lower-order moments.

### Loss Functions:

Negative Log-Likelihood (NLL): This is a common choice for generative models, where the loss is the negative log of the probability that the MPS assigns to the training data. Minimizing NLL encourages the MPS to increase the probability of observed data.

Kullback-Leibler (KL) Divergence: KL divergence measures the difference between two probability distributions. When used as a loss function, it encourages the MPS to produce a distribution that is similar to the target distribution.

Jensen-Shannon (JS) Divergence: A symmetric and smoothed version of the KL divergence, the JS divergence measures the similarity between two probability distributions and is often used as a loss function for generative models.

Mean Squared Error (MSE): For continuous distributions, the MSE between the probability densities predicted by the MPS and the target densities can be used as a loss function.

Cross-Entropy: In the context of probability distributions, cross-entropy can be used to measure the difference between the target distribution and the distribution represented by the MPS.

Earth Mover's Distance (EMD): Also known as Wasserstein distance, EMD is a measure of the distance between two probability distributions over a region D. It is particularly useful when the model needs to capture the underlying geometry of the probability space.

The choice of optimization technique and loss function depends on the specific characteristics of the problem, the nature of the target distribution, and the computational resources available. In practice, a combination of these methods may be used, and hyperparameters such as learning rates and batch sizes are tuned to achieve the best performance.

Embodiments of the Present Invention incorporate a novel feature in the form of a trainable compression layer within the Matrix Product State (MPS) tensor network. This compression layer is designed to reduce the cardinality of the tunable tensors, resulting in a more compact and computationally efficient network. Despite the reduction in the number of parameters, the network retains its ability to approximate the target probability density function with high precision.

The compression layer operates by applying a learned transformation to the high-dimensional feature vectors obtained from the initial mapping of the continuous data variables. This transformation is represented by a set of isometric matrices, which are optimized during the training process. The isometries effectively rotate and truncate the feature space, selecting the most relevant dimensions that are then connected to the MPS layer.

By incorporating the compression layer, the invention achieves several key advantages:

Efficiency: The compression layer reduces the computational cost associated with the MPS by decreasing the size of the tensors that need to be optimized. This leads to faster training times and lower memory requirements.

Expressiveness: Despite the reduction in tensor size, the compression layer is trained to preserve the essential features of the data. This ensures that the compressed MPS can still capture the complex correlations present in the target distribution.

Flexibility: The trainable nature of the compression layer allows it to adapt to the specific characteristics of the dataset. It learns to compress the data in a way that is most beneficial for modeling the target function.

Scalability: By mitigating the curse of dimensionality, the compression layer enables the MPS to scale to higher-dimensional data without a proportional increase in computational resources.

Generalization: The compression layer helps prevent overfitting by reducing the number of tunable parameters, promoting a model that generalizes better to unseen data.

The trainable compression layer enhances the tensor network's ability to efficiently and accurately model complex probability distributions. It represents a significant advancement in the field of generative modeling, particularly for applications involving high-dimensional data.

One feature of embodiments of the present invention is the inclusion of a compression layer that comprises a plurality of isometry matrices. These matrices serve a dual purpose: they perform a rotation in the feature space and execute a truncation process. This innovative approach to data compression optimizes the network's memory and computational resource usage, which is particularly advantageous when dealing with high-dimensional data.

The isometry matrices are carefully designed to preserve the inner product between vectors in the feature space, effectively maintaining the geometric relationships between data points while reducing dimensionality. The rotation aspect of the isometry matrices ensures that the most significant features of the data are aligned with the axes of the reduced feature space. This alignment maximizes the retention of relevant information post-truncation.

Following the rotation, the isometry matrices truncate the feature space, discarding the less informative dimensions. This truncation significantly reduces the number of parameters within the MPS tensor network, leading to a more compact representation of the data. The compression layer's ability to selectively preserve the most critical features allows the network to maintain high precision in approximating the target function, despite the reduction in dimensionality.

The optimization of memory and computational resources is achieved through the following mechanisms:

Reduced Parameter Space: By truncating the feature space, the compression layer decreases the total number of tunable parameters within the MPS, leading to a more memory-efficient model.

Enhanced Computational Efficiency: The reduction in parameters directly translates to fewer computations required during both the forward and backward passes of training, resulting in faster convergence and reduced processing time.

Scalability: The compression layer enables the MPS tensor network to scale to larger datasets and higher dimensions without a proportional increase in computational demand, making it suitable for a wide range of applications.

Adaptive Compression: The isometry matrices are not static; they are trainable components of the network. During the training process, they adapt to the specific structure of the data, ensuring that the compression is optimized for the task at hand.

Resource Management: By managing the trade-off between information retention and resource usage, the compression layer ensures that the network remains both effective and efficient, even as the complexity of the data or the model increases.

In summary, the compression layer with its isometry matrices is a pivotal feature of the invention, enhancing the MPS tensor network's ability to process large and complex datasets with high precision while optimizing the usage of memory and computational resources.

Some advantages of the compression layer include:

Saves Space: Just like packing only the essentials can save space in your luggage, the compression layer reduces the amount of space needed to store data, making it more manageable.

Speeds Up Processing: With less data to work through, your computer can process information faster, much like how it's quicker to find your socks in a neatly packed drawer than a cluttered closet.

Adapts to Needs: The compression layer isn't one-size-fits-all; it adjusts to focus on the most important parts of the data, similar to how you might pack differently for a beach vacation versus a business trip.

Efficient Use of Resources: By keeping the data compact, the compression layer ensures that the computer's energy and resources aren't wasted, akin to saving fuel by not driving a big truck when a small car will do.

Handles More Data: Even as the amount of data grows, the compression layer helps manage it without needing a bigger “suitcase,” allowing for the handling of more information without extra burden.

Embodiments of the present invention enhance the performance of the Matrix Product State (MPS) tensor network through the integration of two powerful optimization techniques: gradient descent and the Density Matrix Renormalization Group (DMRG). These techniques work in tandem to fine-tune the network, ensuring that it operates at peak efficiency and accuracy.

Gradient descent is a mathematical method used to improve the network by iteratively adjusting its parameters to minimize errors. Picture this as trying to find the lowest point in a hilly landscape. At each step, gradient descent evaluates the slope and takes a step in the direction that leads most steeply downhill. By repeatedly taking such steps, it eventually reaches the lowest point, which corresponds to the best performance of the network.

The DMRG technique, originally developed for quantum physics applications, is a sophisticated strategy for managing the complexity of the network. It systematically refines the network by focusing on the most significant components and trimming away redundancies. Imagine a sculptor who starts with a rough block of stone and gradually chisels away at it to reveal a detailed statue. DMRG works similarly by discarding the less important parts of the network, revealing a more streamlined and effective model.

By combining gradient descent and DMRG, the invention achieves a highly optimized MPS tensor network that is both lean and powerful. This optimization process leads to several benefits:

Enhanced Precision: The network becomes more accurate in modeling and predicting, much like a well-calibrated instrument.

Increased Efficiency: Optimization reduces unnecessary computations, making the network faster and more responsive.

Improved Scalability: The network can handle larger and more complex datasets without a loss in performance.

Resource Optimization: The network makes better use of computational resources, avoiding waste and ensuring that every calculation counts.

Robust Learning: The network learns more effectively from the data, leading to better outcomes and insights.

In summary, the MPS tensor network's optimization through gradient descent and DMRG techniques results in a robust, efficient, and precise tool for handling complex data. This feature of the invention is crucial for delivering high-quality results in various applications that rely on advanced data analysis.

Embodiments of the Present Invention incorporate a comprehensive preprocessing methodology for datasets, which is useful for priming the data before it is fed into the Matrix Product State (MPS) tensor network. This preprocessing includes a series of steps-normalization, scaling, and dynamic basis adjustment—that collectively enhance the network's performance by ensuring the data is in an optimal format for processing.

Normalization is the process of adjusting the data to ensure that different features contribute equally to the analysis. Imagine you have a group of people of varying heights and weights; normalization would convert these measurements into a standard range, allowing for a fair comparison without one feature dominating the others due to scale differences.

Scaling adjusts the range of the data to a defined scope, typically between zero and one, or to a standard deviation around zero. This is akin to adjusting the volume on your devices to a standard level so that all sounds are audible but not too loud. Scaling ensures that all data points are within a manageable range, preventing any single value from disproportionately influencing the network's behavior.

Dynamic basis adjustment is a more advanced step that involves transforming the data into a format that is particularly suited to the MPS tensor network. This step is like tuning an instrument to the right pitch before a concert; it ensures that the data resonates well with the network's architecture. By dynamically adjusting the basis, the network can more effectively capture the underlying patterns and relationships within the data.

These preprocessing steps are beneficial for the following reasons:

Data Compatibility: They transform the data into a format that is compatible with the MPS tensor network's requirements.

Improved Accuracy: By standardizing the data, the network can make more accurate predictions and analyses.

Enhanced Learning: The network can learn more efficiently from preprocessed data, which can lead to faster training times and better generalization.

Robustness to Variability: Preprocessing reduces the variability caused by irrelevant differences in the data, such as units of measurement, ensuring that the network focuses on the true signals.

Optimal Resource Use: With data in a standardized form, the network can operate more efficiently, making better use of computational resources.

In summary, the preprocessing steps of normalization, scaling, and dynamic basis adjustment are integral to the invention, setting the stage for the MPS tensor network to perform at its best. These steps ensure that the data is clean, well-organized, and primed for the complex computations that follow, ultimately leading to superior performance and more insightful results.

One feature of embodiments of the present invention is the ability of the trained and compressed Matrix Product State (MPS) tensor network to generate synthetic data samples. This capability is not just a byproduct of the network's processing power but a deliberate design that serves a multitude of practical applications across diverse sectors such as finance, healthcare, and logistics.

Once the MPS tensor network has been adequately trained and compressed, it holds within its structure a distilled essence of the original dataset. This distilled knowledge enables the network to create new, artificial data points that statistically mirror the real data it learned from. The process of generating these synthetic data samples is akin to an artist who, after studying a subject, can create numerous new sketches that capture the essence of the original.

The synthetic data generated by the MPS tensor network has several valuable applications:

Finance: In the financial sector, synthetic data can be used to model complex market scenarios, stress test portfolios, and develop robust financial strategies without exposing sensitive information.

Healthcare: Synthetic patient records that closely resemble real patient data-without compromising individual privacy—can be a boon for medical research, allowing for extensive data analysis and clinical trials while adhering to strict confidentiality regulations.

Logistics: The logistics industry can benefit from synthetic data to optimize supply chain processes, forecast demand, and simulate the impact of disruptions or changes in the network, leading to more resilient and efficient operations.

The advantages of using synthetic data include:

Privacy Preservation: Synthetic data contains no real-world personal information, thus mitigating privacy concerns and compliance risks associated with data protection laws.

Enhanced Data Availability: It allows for the creation of rich datasets where real data may be scarce or too sensitive to use, such as in rare disease research or proprietary financial models.

Improved Model Testing: Synthetic data provides a safe environment to test and validate new models or systems before deploying them in real-world scenarios.

Innovation Facilitation: By providing a sandbox of realistic yet not real data, the MPS tensor network encourages experimentation and innovation without the constraints of data scarcity or privacy issues.

In essence, the trained and compressed MPS tensor network serves as a sophisticated data synthesizer, capable of producing high-quality, artificial datasets that can be leveraged to drive research, development, and strategic planning in various industries, all while maintaining the utmost respect for privacy and data integrity.

Model compression can be applied as a practical use case for CVTN in the following examples.

### Edge Computing:

CVTN can be used to compress large machine learning models to fit the limited storage and processing capabilities of edge devices, such as smartphones, IoT devices, and sensors. This enables complex analytics and real-time decision-making at the edge, closer to where data is generated.

### Real-Time Analytics:

In scenarios where quick data processing is critical, such as financial trading or emergency response, CVTN can compress models to facilitate faster loading times and execution speeds, enabling real-time analytics and immediate action based on complex data analysis.

### Bandwidth Optimization:

When models need to be transmitted over networks, especially in bandwidth-constrained environments, CVTN can compress the models to reduce the data size, leading to lower transmission times and costs, and less strain on network resources.

### Cloud Computing:

Cloud service providers can use CVTN to compress models before deployment, reducing the computational resources required for running machine learning workloads. This can lead to cost savings for both providers and users, as well as increased efficiency in cloud-based services.

### Embedded Systems:

CVTN can compress models for use in embedded systems within automobiles, medical devices, or industrial machinery, where space and computational power are at a premium. Compressed models enable sophisticated functionalities without compromising the system's performance or design.

### Energy Efficiency:

By reducing the size and complexity of models, CVTN can contribute to lower energy consumption during model training and inference, which is crucial for sustainable computing practices and reducing the carbon footprint of data centers.

### Privacy-Preserving Machine Learning:

CVTN can compress models in a way that reduces the risk of reverse engineering and data leakage. This is particularly important for models trained on sensitive data, as it helps maintain privacy while still allowing for the deployment of powerful analytics tools.

### Scalable AI Deployment:

Organizations with large-scale AI deployments can benefit from CVTN by compressing models to ensure that they can be efficiently scaled across multiple servers or devices without a linear increase in resource demands.

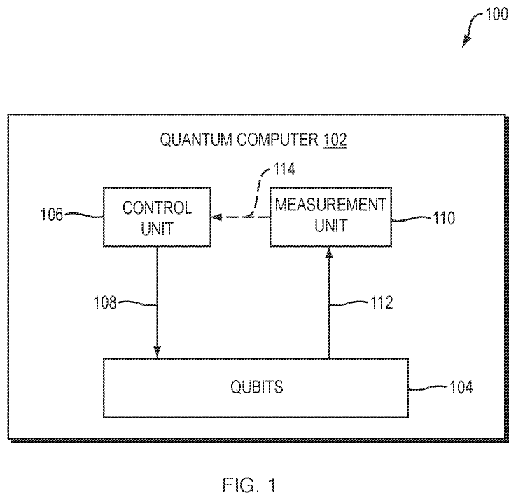

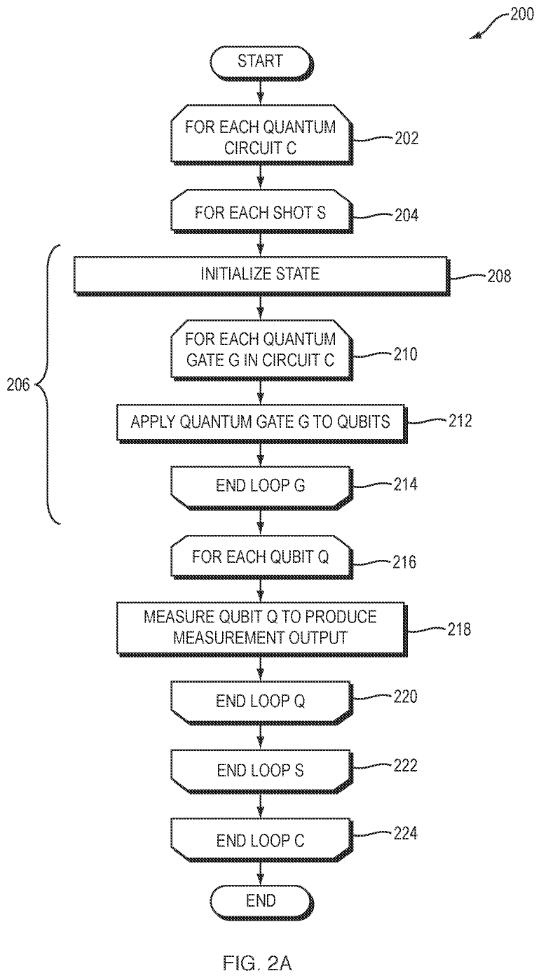

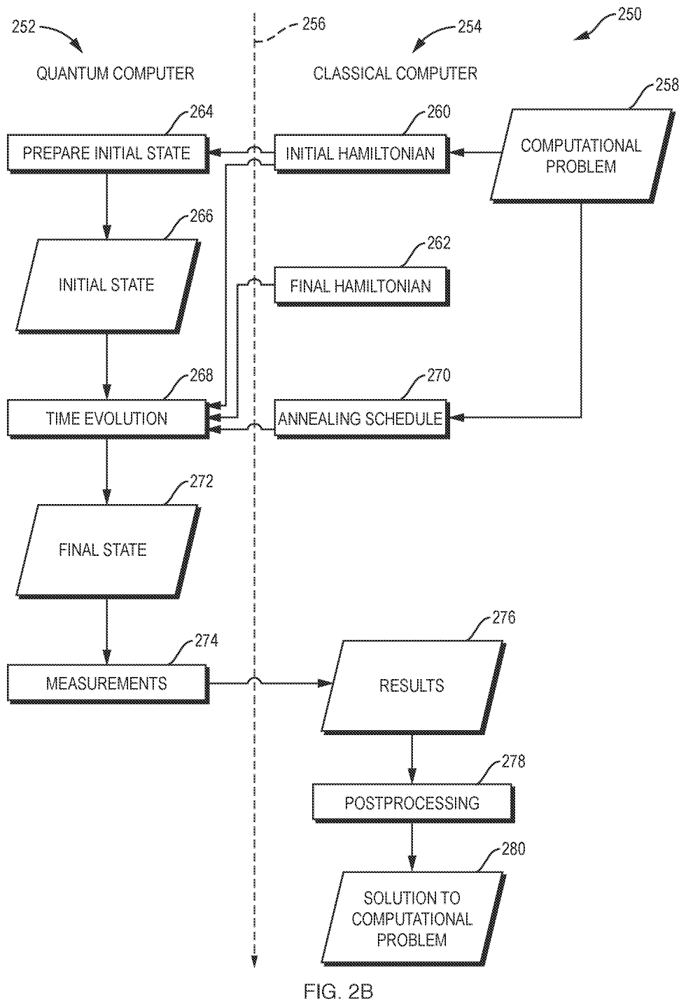

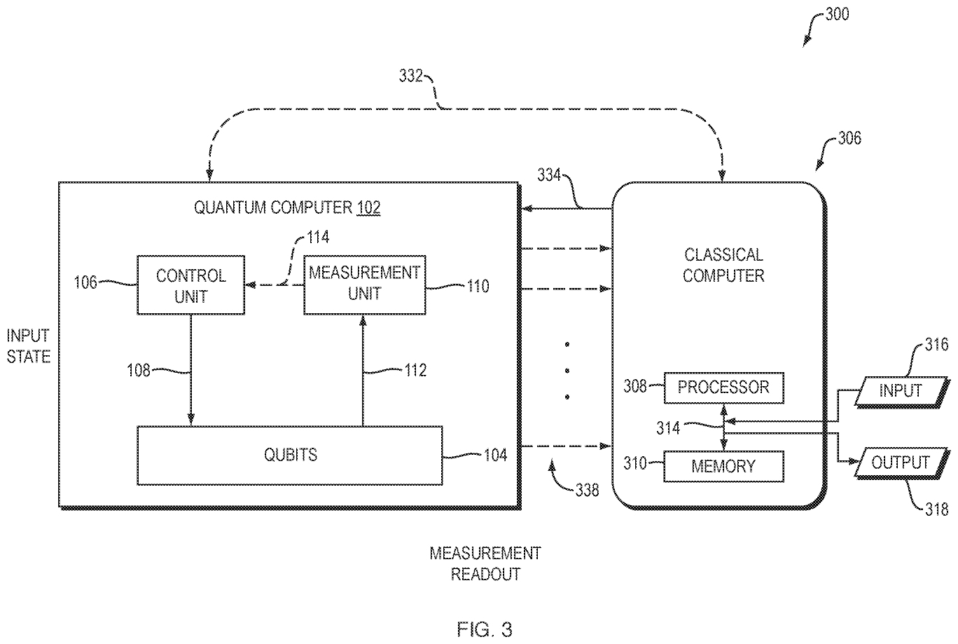

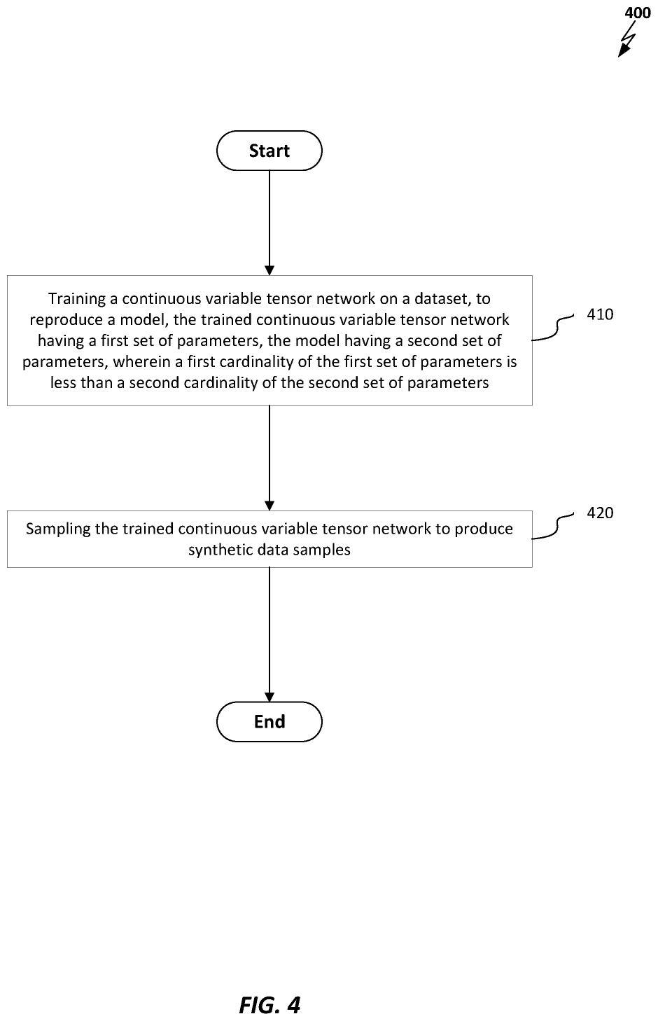

FIG. 1 is a flowchart of an example method 100 for model compression. The method 100 may be performed by at least one computer processor executing computer program instructions stored on at least one non-transitory computer readable medium. The method 100 includes training a continuous variable tensor network (CVTN) on a dataset, to reproduce a model, the trained continuous variable tensor network having a first set of parameters, the model having a second set of parameters, wherein a first cardinality of the first set of parameters is less than a second cardinality of the second set of parameters (operation 110). The method 100 also includes sampling the trained continuous variable tensor network to produce synthetic data samples (operation 120). Sampling from the CVTN may be approximately equal to sampling from the model.

Training the continuous variable tensor network may include employing a trainable compression layer technique to dynamically adjust the bond dimensions of the tunable tensors during the optimization process.

The compression layer may further be configured to selectively hybridize basis functions.

Training the continuous variable tensor network may utilize a learning rate schedule that adapts based on a convergence rate.

The dataset may include a combination of synthetic and real-world data.

Training the continuous variable tensor network may include preprocessing steps to normalize and scale continuous variables within a specified range.

The preprocessing steps may include mapping the continuous data to a feature space using a set of orthonormal basis functions selected based on a domain of the data.

The preprocessing steps may further include a discretization step that converts continuous variables into a finite set of intervals.

The method may further include partitioning the dataset into training and validation subsets; and evaluating the performance of the continuous variable tensor network on the validation subset to determine the model's generalization capability.

The continuous variable tensor network may be a continuous-valued matrix product state.

It is to be understood that although the invention has been described above in terms of particular embodiments, the foregoing embodiments are provided as illustrative only, and do not limit or define the scope of the invention. Various other embodiments, including but not limited to the following, are also within the scope of the claims. For example, elements and components described herein may be further divided into additional components or joined together to form fewer components for performing the same functions.

Any of the functions disclosed herein may be implemented using means for performing those functions. Such means include, but are not limited to, any of the components disclosed herein, such as the computer-related components described below.

The techniques described above may be implemented, for example, in hardware, in one or more computer programs tangibly stored on one or more computer-readable media, firmware, or any combination thereof, such as solely on a quantum computer, solely on a classical computer, or on a hybrid quantum classical (HQC) computer. The techniques disclosed herein may, for example, be implemented solely on a classical computer, in which the classical computer emulates the quantum computer functions disclosed herein.

The techniques described above may be implemented in one or more computer programs executing on (or executable by) a programmable computer (such as a classical computer, a quantum computer, or an HQC) including any combination of any number of the following: a processor, a storage medium readable and/or writable by the processor (including, for example, volatile and non-volatile memory and/or storage elements), an input device, and an output device. Program code may be applied to input entered using the input device to perform the functions described and to generate output using the output device.

Embodiments of the present invention include features which are only possible and/or feasible to implement with the use of one or more computers, computer processors, and/or other elements of a computer system. Such features are either impossible or impractical to implement mentally and/or manually. For example, one application of tensor networks is in modeling high-dimensional data, which may have millions or even billions of weights, which would be impossible for a human to learn. These models may then help compute otherwise computationally intractable problems that admit no other efficient solution.

Any claims herein which affirmatively require a computer, a processor, a memory, or similar computer-related elements, are intended to require such elements, and should not be interpreted as if such elements are not present in or required by such claims. Such claims are not intended, and should not be interpreted, to cover methods and/or systems which lack the recited computer-related elements. For example, any method claim herein which recites that the claimed method is performed by a computer, a processor, a memory, and/or similar computer-related element, is intended to, and should only be interpreted to, encompass methods which are performed by the recited computer-related element(s). Such a method claim should not be interpreted, for example, to encompass a method that is performed mentally or by hand (e.g., using pencil and paper). Similarly, any product claim herein which recites that the claimed product includes a computer, a processor, a memory, and/or similar computer-related element, is intended to, and should only be interpreted to, encompass products which include the recited computer-related element(s). Such a product claim should not be interpreted, for example, to encompass a product that does not include the recited computer-related element(s).

In embodiments in which a classical computing component executes a computer program providing any subset of the functionality within the scope of the claims below, the computer program may be implemented in any programming language, such as assembly language, machine language, a high-level procedural programming language, or an object-oriented programming language. The programming language may, for example, be a compiled or interpreted programming language.

Each such computer program may be implemented in a computer program product tangibly embodied in a machine-readable storage device for execution by a computer processor, which may be either a classical processor or a quantum processor. Method steps of the invention may be performed by one or more computer processors executing a program tangibly embodied on a computer-readable medium to perform functions of the invention by operating on input and generating output. Suitable processors include, by way of example, both general and special purpose microprocessors. Generally, the processor receives (reads) instructions and data from a memory (such as a read-only memory and/or a random access memory) and writes (stores) instructions and data to the memory. Storage devices suitable for tangibly embodying computer program instructions and data include, for example, all forms of non-volatile memory, such as semiconductor memory devices, including EPROM, EEPROM, and flash memory devices; magnetic disks such as internal hard disks and removable disks; magneto-optical disks; and CD-ROMs. Any of the foregoing may be supplemented by, or incorporated in, specially-designed ASICs (application-specific integrated circuits) or FPGAs (Field-Programmable Gate Arrays). A classical computer can generally also receive (read) programs and data from, and write (store) programs and data to, a non-transitory computer-readable storage medium such as an internal disk (not shown) or a removable disk. These elements will also be found in a conventional desktop or workstation computer as well as other computers suitable for executing computer programs implementing the methods described herein, which may be used in conjunction with any digital print engine or marking engine, display monitor, or other raster output device capable of producing color or gray scale pixels on paper, film, display screen, or other output medium.

Any data disclosed herein may be implemented, for example, in one or more data structures tangibly stored on a non-transitory computer-readable medium (such as a classical computer-readable medium, a quantum computer-readable medium, or an HQC computer-readable medium). Embodiments of the invention may store such data in such data structure(s) and read such data from such data structure(s).

Although terms such as “optimize” and “optimal” are used herein, in practice, embodiments of the present invention may include methods which produce outputs that are not optimal, or which are not known to be optimal, but which nevertheless are useful. For example, embodiments of the present invention may produce an output which approximates an optimal solution, within some degree of error. As a result, terms herein such as “optimize” and “optimal” should be understood to refer not only to processes which produce optimal outputs, but also processes which produce outputs that approximate an optimal solution, within some degree of error.

What is claimed is:

1. A method for model compression, the method performed by at least one computer processor executing computer program instructions stored on at least one non-transitory computer readable medium, the method comprising:
training a continuous variable tensor network on a dataset, to reproduce a model, the trained continuous variable tensor network having a first set of parameters, the model having a second set of parameters, wherein a first cardinality of the first set of parameters is less than a second cardinality of the second set of parameters; and
sampling the trained continuous variable tensor network to produce synthetic data samples.

2. The method of claim 1, wherein training the continuous variable tensor network includes employing a trainable compression layer technique to dynamically adjust the bond dimensions of the tunable tensors during the optimization process.

3. The method of claim 2, wherein the compression layer is further configured to selectively hybridize basis functions.

4. The method of claim 1, wherein training the continuous variable tensor network utilizes a learning rate schedule that adapts based on a convergence rate.

5. The method of claim 1, wherein the dataset comprises a combination of synthetic and real-world data.

6. The method of claim 1, wherein training the continuous variable tensor network includes preprocessing steps to normalize and scale continuous variables within a specified range.

7. The method of claim 6, wherein the preprocessing steps include mapping the continuous data to a feature space using a set of orthonormal basis functions selected based on a domain of the data.

8. The method of claim 6, wherein the preprocessing steps further include a discretization step that converts continuous variables into a finite set of intervals.

9. The method of claim 1, further comprising:
partitioning the dataset into training and validation subsets; and
evaluating the performance of the continuous variable tensor network on the validation subset to determine the model's generalization capability.

10. The method of claim 1, wherein the continuous variable tensor network is a continuous-valued matrix product state.

11. A system for model compression, the system comprising at least one non-transitory computer readable medium having computer program instructions stored thereon, computer program instructions being executable by at least one computer processor to perform a method, the method comprising:
training a continuous variable tensor network on a dataset, to reproduce a model, the trained continuous variable tensor network having a first set of parameters, the model having a second set of parameters, wherein a first cardinality of the first set of parameters is less than a second cardinality of the second set of parameters; and
sampling the trained continuous variable tensor network to produce synthetic data samples.

12. The system of claim 11, wherein training the continuous variable tensor network includes employing a trainable compression layer technique to dynamically adjust the bond dimensions of the tunable tensors during the optimization process.

13. The system of claim 12, wherein the compression layer is further configured to selectively hybridize basis functions.

14. The system of claim 11, wherein training the continuous variable tensor network utilizes a learning rate schedule that adapts based on a convergence rate.

15. The system of claim 11, wherein the dataset comprises a combination of synthetic and real-world data.

16. The system of claim 11, wherein training the continuous variable tensor network includes preprocessing steps to normalize and scale continuous variables within a specified range.

17. The system of claim 16, wherein the preprocessing steps include mapping the continuous data to a feature space using a set of orthonormal basis functions selected based on a domain of the data.

18. The system of claim 16, wherein the preprocessing steps further include a discretization step that converts continuous variables into a finite set of intervals.

19. The system of claim 11, wherein the method further comprises:
partitioning the dataset into training and validation subsets; and
evaluating the performance of the continuous variable tensor network on the validation subset to determine the model's generalization capability.

20. The system of claim 11, wherein the continuous variable tensor network is a continuous-valued matrix product state.
